(19) United States
(12) Patent Application Publication
(10) Pub. No.: US 2011/0113426 A1
(43) Pub. Date: May 12, 2011

(54) APPARATUSES FOR SWITCHING THE RUNNING OF A VIRTUAL MACHINE BETWEEN MULTIPLE COMPUTER DEVICES BELONGING TO THE SAME COMPUTER PLATFORM AND THE ASSOCIATED SWITCHING METHODS

(76) Inventors: Hsiang-Tsung KUNG, Taipei City (TW); Teng-Chang Chang, Taipei City (TW); Kuang-Ming Wang, Liujia Township (TW)

(21) Appl. No.: 12/614,860

(22) Filed: Nov. 9, 2009

(51) Int. Cl. G06F 9/455; G06F 9/46; G06F 12/00

(52) U.S. Cl. 718/1; 711/147; 718/104; 711/E12.001

(57) ABSTRACT

An apparatus for managing a running virtual machine on a desktop or laptop platform includes a first computer device, a second computer device and a shared memory. The first computer device has a first switching hypervisor on which a virtual machine runs. The second computer device has a second switching hypervisor, wherein the second switching hypervisor is in communication with the first switching hypervisor. The shared memory is coupled to the first and second computer devices, and is accessible by the first and second switching hypervisors, wherein the first switching hypervisor stores status information of the virtual machine into the shared memory. When receiving a switching notification for switching the virtual machine to run on the second computer device, the first switching hypervisor halts its running of the virtual machine, and then the second switching hypervisor obtains the stored status information of the virtual machine from the shared memory and resumes the running of the virtual machine on the second computer device according to the obtained status information of the virtual machine.

### BACKGROUND OF THE INVENTION

1. Field of the Invention

The disclosure relates generally to the management of a virtual machine running on a desktop or laptop platform consisting of multiple homogeneous or heterogeneous CPUs, and, more particularly to apparatuses for managing the switching of a running virtual machine between two or more computer devices belonging to the same computer platform.

2. Description of the Related Art

Virtualization of computing systems has become quite prevalent in recent times. Virtualization refers to a new layer that abstracts computer hardware from an operating system (OS) and applications that run on it. Virtualization techniques allow computer hardware to support concurrent running of more than one operating system. Also, operating systems and associated applications, held in containers called virtual machines, are controlled and scheduled by a hypervisor (or so-called a virtual machine monitor (VMM)). The hypervisor is a computer software/hardware platform virtualization software that allows multiple virtual machines to run on a host computer concurrently. The hypervisor may provide a set of virtual resources such as a virtual CPU, memory and IO device for applications that run on it. The hypervisor may map portions or all of the physical hardware devices of the host computer into a virtual machine and generate virtual devices contained in the virtual machine. The hypervisor may utilize the virtualized hardware devices to provide services for the virtual machine and protection for multiple virtual machines running on it.

Current virtualization technology allows more than one virtual machine with a virtual OS and a set of virtualized hardware devices to be run on the same computer architecture. For example, using current virtualization technology, a single x86-based computer system may host one or more ARM-based or x86-based virtual machines. However, it does not support dynamic switching on the running of the same virtual machine between multiple homogeneous or heterogeneous CPUs which constitute a single computer system such as a desktop or laptop. There are important advantages of being able to support this dynamic switching between CPUs. For example, during a period when a virtual machine applies only a light workload to a CPU, it can be switched to another CPU where multiple workloads can be consolidated. This will allow the original CPU to be put into standby or a power-saving mode to reduce total power consumption of the system. For a hybrid desktop or laptop platform with heterogeneous CPUs, such as x86 and ARM, a x86 virtual machine for example can generally use the ARM CPU to reduce power consumption, but at times when it is required to run CPU-bound x86 applications (e.g., multimedia encoding /decoding) the virtual machine can be dynamically switched to run on top of the x86 CPU.

Thus, there is a need for new methods for managing a virtual machine between multiple computer devices embedded in a single platform.

### BRIEF SUMMARY OF THE INVENTION

It is therefore an objective to provide an improved and effective method for managing a virtual machine between multiple homogeneous or heterogeneous computer devices embedded in a single system.

An embodiment of an apparatus for managing a running virtual machine includes a first computer device, a second computer device and a shared memory. The first computer device has a first switching hypervisor on which a virtual machine runs. The second computer device has a second switching hypervisor, wherein the second switching hypervisor is in communication with the first switching hypervisor. The shared memory is coupled to the first and second computer devices, and is accessible by the first and second switching hypervisors, wherein the first switching hypervisor stores status information of the virtual machine into the shared memory. When receiving a switching notification for switching the virtual machine to the second computer device, the first switching hypervisor halts its running of the virtual machine. The second switching hypervisor then obtains the stored status information of the virtual machine from the shared memory and resumes the running of the virtual machine on the second computer device according to the obtained status information of the virtual machine.

In one embodiment, a switching method for switching a running virtual machine between computer devices in an apparatus comprising at least first and second computer devices and a shared memory coupled therebetween is provided, wherein the first computer device has a first switching hypervisor on which a virtual machine runs and the second computer device has a second switching hypervisor, which is in communication with the first switching hypervisor. The method comprises the following steps. First, status information of the running virtual machine is stored into the shared memory by the first switching hypervisor of the first computer device when the virtual machine runs on the first computer device. Then, a switching notification for switching the virtual machine to the second computer device is received. Thereafter, the stored status information of the virtual machine is obtained from the shared memory and the running of the virtual machine is resumed on the second computer device by the second switching hypervisor according to the obtained status information of the virtual machine.

Switching methods and apparatuses may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an apparatus 100 for managing a running virtual machine of the invention;

FIG. 2 illustrates an embodiment of a shared-memory of the invention;

FIG. 3 is a flowchart of an embodiment of a method for selecting a running virtual machine in an apparatus of the invention; and

FIG. 4 is a flowchart of an embodiment of a switching method for switching a running virtual machine from a first computer device to a second computer device in an apparatus of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

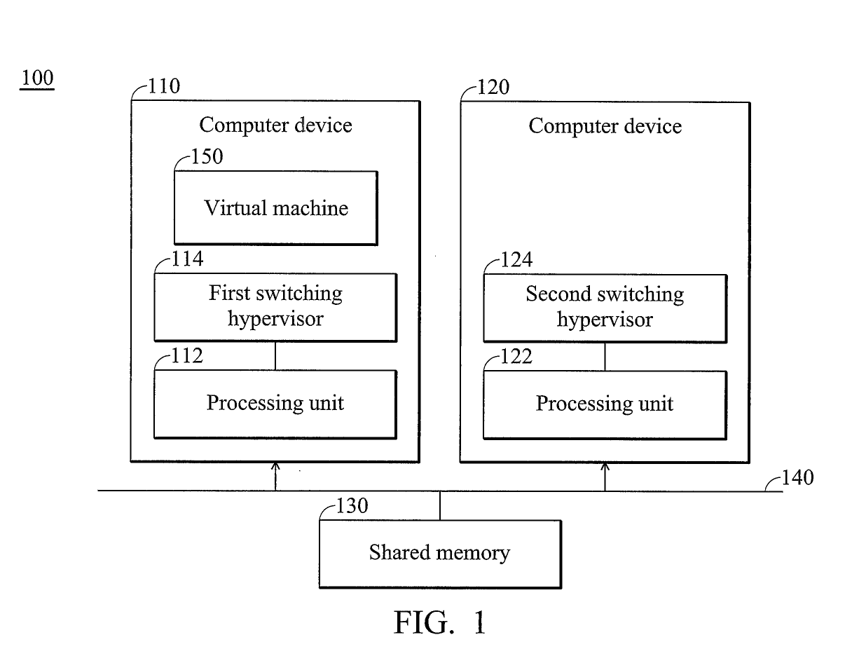

FIG. 1 is a schematic diagram illustrating an embodiment of an apparatus 100 for managing a running virtual machine of the invention. The apparatus 100 at least comprises two or more computer devices 110 and 120, a shared memory 130 and a connection interface 140. A virtual machine 150 is capable of running between the computer devices 110 and 120. Each computer device may further comprise a processing unit for controlling operation of the computer device, and a switching hypervisor for handling the running of a virtual machine 150. The virtual machine 150 which is generated and controlled by the switching hypervisor of the computer device 110 or 120 may comprise a virtual CPU (central processing unit), a memory and a set of virtual hardware devices. For example, as shown in FIG. 1, the computer device 110 may comprise a processing unit 112 for controlling operation of the computer device 110 and a first switching hypervisors 114 for handling the running of the virtual machine 150. The computer device 120 may comprise a processing unit 122 and a second switching hypervisors 124 which is in communication with the first switching hypervisors 114 for handling the running of a virtual machine. The computer device 120 is connected to the computer device 110 via the connection interface 140.

The computer devices 110 and 120 may have processing units with the same or different processing unit type and hardware devices. In one embodiment, for example, the computer devices 110 and 120 may have processing units with the same processing unit type, such as the x86 series CPU (central processing unit), running the same operating system (OS), such as the Windows-based OS. In another embodiment, the computer devices 110 and 120 may have processing units with different processing unit types running different OSs. For example, the processing unit type of the computer device 110 may be the x86 series CPU and the processing unit type of the computer device 120 may be an ARM processor. Also, the OS type of the computer device 110 may be a Window-based OS while the OS type of the computer device 120 may be a Linux-based OS.

The shared memory 130 is coupled to and accessible by the computer devices 110 and 120 and thus is also accessible by the first and second switching hypervisors 114 and 124. The shared memory 130 may host the entire physical memory used by the running virtual machine or a portion of the physical memory. It is to be understood that the shared memory 130 may be implemented by software (e.g., a daemon providing a shared view for a collection of separate memory systems) or by hardware such as any type of globally accessible memory structure. The computer devices 110 and 120 may connect to the shared-memory 130 through a connection interface 140. The connection interface 140 is coupled to the computer device 110 and the computer device 120 for the first switching hypervisor 114 to communicate with the second switching hypervisor 124. The connection interface 140 may be, for example, any kind of bus device such as a PCI-E bus device.

In operation, the first switching hypervisor 114 that is currently running on the virtual machine 150 may continually store status information of the virtual machine 150 into the shared memory 130. The status information of the virtual machine 150 may comprise, for example, information regarding CPU registers and states, peripherals states, and the memory content of the virtual machine 150 in the computer device 110 or 120.

The information regarding the CPU registers and states, the peripherals states, and the memory content of the virtual machine 150 in the computer device 110 may be stored in specific memory locations of the shared memory 130. Therefore, when the running of the virtual machine 150 is switched to the computer device 120, the computer device 120 may directly retrieve the stored information from the specific memory locations of the shared memory 130 to obtain the status information of the virtual machine 150.

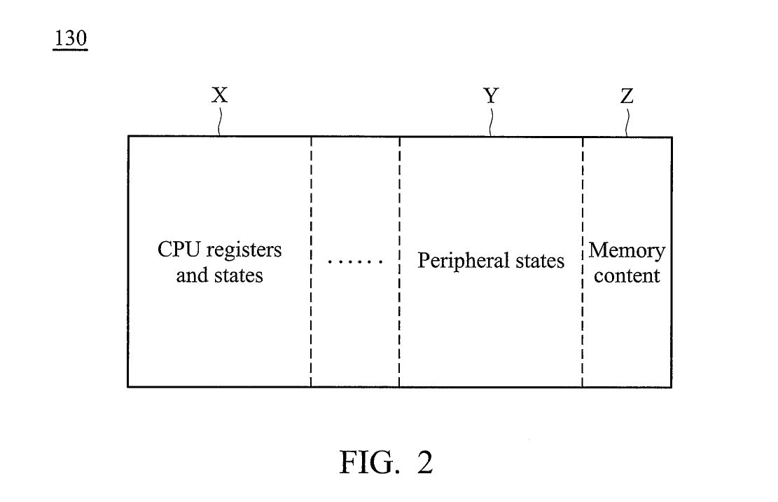

FIG. 2 illustrates an embodiment of a shared-memory 130 of the invention. As shown in FIG. 2, as an example, a memory address X, a memory address Y and a memory address Z represent starting addresses for memory blocks containing information regarding the CPU registers and states, the peripherals states and the memory content of the virtual machine respectively so that the computer device 120 may obtain the information regarding, for example, the CPU registers and states of the virtual machine from the memory address X of the shared memory 130.

When a user attempts to switch the running virtual machine from the computer device 110 to the computer device 120, a switching notification for switching the virtual machine 150 to the computer device 120 will be triggered and sent to the first switching hypervisor 114. When receiving the switching notification, the first switching hypervisor 114 halts running of the virtual machine 150 and passes the switching notification to the second switching hypervisor 124 via the connection interface 140. After receiving the switching notification, the second switching hypervisor 124 obtains the stored status information of the virtual machine 150 from the shared memory 130. Also, a virtual machine is configured to run on the computer device 120 according to the obtained status information of the virtual machine 150 from the shared memory 130 to resume the running of the virtual machine 150 on the computer device 120. Since the information regarding the CPU registers and states, the peripherals states, and the memory content of the virtual machine in the computer system 110 may be stored in specific memory locations of the shared memory 130 (e.g. as shown in FIG. 2), the computer device 120 may directly retrieve the stored information from the specific memory locations of the shared memory 130 to obtain the status information of the virtual machine 150.

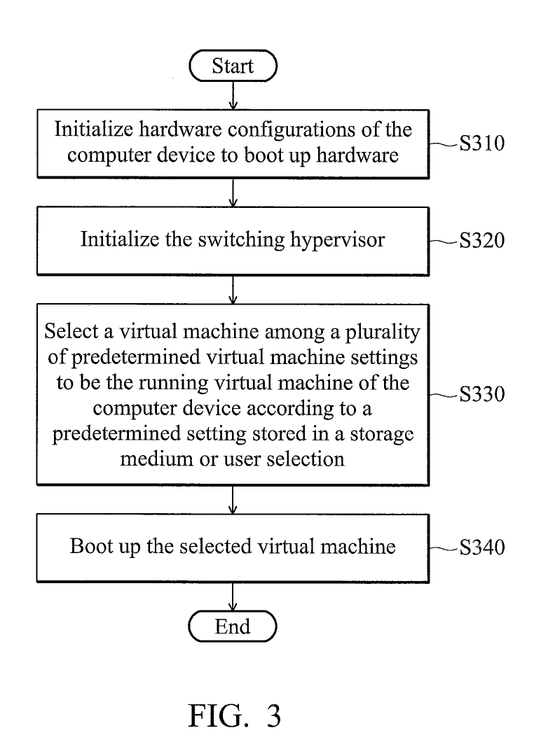

FIG. 3 is a flowchart of an embodiment of a method for selecting a miming virtual machine in an apparatus of the invention. When a user activates the apparatus 100, the computer device 110 may be first activated by default. Thus, the hardware configurations of the computer device 110 are initialized to boot up the hardware (step S310) and the switching hypervisor 114 thereof may then be initialized (step S320). After the switching hypervisor 114 has been initialized, it may configure a virtual machine. The first switching hypervisor 114 may further select a virtual machine among a plurality of predetermined virtual machine settings to be the running virtual machine of the computer device 110 according to a predetermined setting stored in a storage medium (e.g. a hard disk, a read-only memory or flash memory) or user selection (step S330). After configuration for the virtual machine 150 has been determined, the switching hypervisor 114 may boot up the selected virtual machine so that it may serve as the OS of the computer device 110 (step S340). Note that configuration for the virtual machine 150 may comprise a CPU type configuration and peripheral configurations for the virtual machine 150. If the CPU type configuration of the virtual machine 150 does not match that of the computer device 110 (e.g., the CPU type configuration of the virtual machine 150 is set to be the ARM-based CPU architecture while the CPU type of the computer device 110 is the Intel x86-based CPU architecture), the virtual machine may be required to simulate a set of virtual hardware devices capable of running on the computer device 110 to be run on the computer device 110. The virtual machine 150 may further utilize an instruction translator or an instruction emulator to simulate instruction sets of the first computer device 110 when hardware architecture used in the virtual machine is different from that used in the computer device 110 such that operating system and user applications of the virtual machine 150 may be operated on the hosting computer device 110.

After the virtual machine 150 is run on the computer device 110, a switching method of the invention may further be performed to switch a running virtual machine from a first computer device to a second computer device.

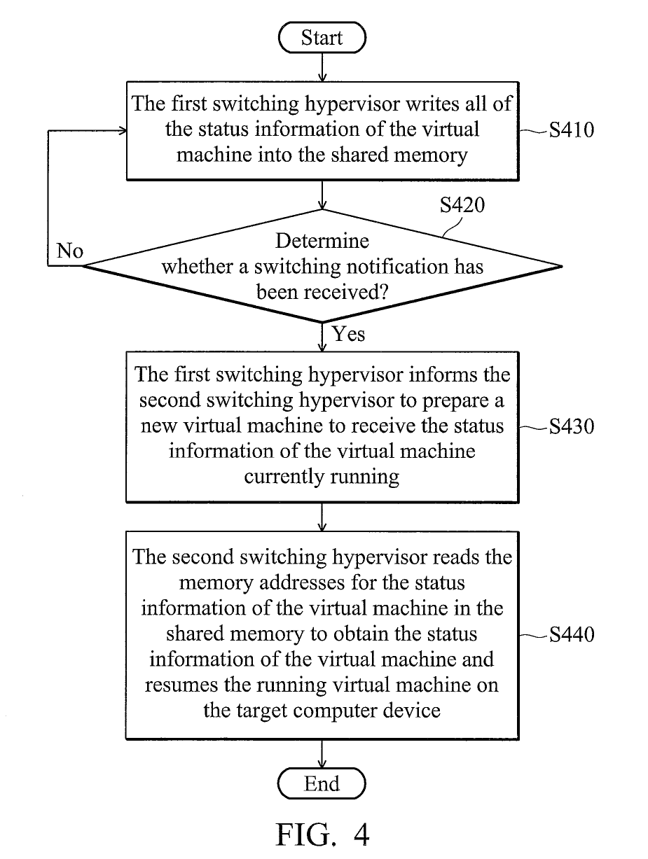

FIG. 4 is a flowchart of an embodiment of a switching method for switching a running virtual machine from a first computer device to a second computer device in an apparatus of the invention. The switching method may be applied to the apparatus 100 as shown in FIG. 1. First, in step S410, assuming that a virtual machine is currently run on the first computer device (i.e., the computer device 110), the first switching hypervisor 114 writes all of the status information of the virtual machine into the shared memory 130 whenever it is running. The status information of the virtual machine 150 may comprise, for example, information regarding CPU registers and states, peripherals states, and the memory content of the virtual machine 150 in the computer device 110. The status information of the virtual machine 150 can be stored in specific memory locations of the shared memory 130. Next, in step S420, it is determined whether a switching notification has been received. If not, step S410 is continually performed by the first switching hypervisor 114 to write all of the status information of the virtual machine. When a user attempts to switch the running of the virtual machine to the second computer device (i.e., the computer device 120), the user may issue a switching notification to the first switching hypervisor 114, wherein the switching notification includes information for the virtual machine, the computer device to be switched to and memory addresses for the status information of the virtual machine in the shared memory 130. After receiving the switching notification (Yes in step S420), in step S430, the first switching hypervisor 114 may communicate with the second switching hypervisor 124 to inform the second switching hypervisor 124 to prepare a new virtual machine instance to receive the status information of the virtual machine currently running. Meanwhile, the first switching hypervisor 114 may halt all of the operations for the virtual machine. After the new virtual machine instance on the target computer device (i.e., the computer device 120) is ready, in step S440, the first switching hypervisor 114 informs the second switching hypervisor 124 to read the memory addresses for the status information of the virtual machine in the shared memory 130 to obtain the status information of the previously run virtual machine so as to resume the running virtual machine on the target computer device.

In this embodiment, the status information of the virtual machine is continually updated and stored in the shared memory 130 rather than copied to the target computer device so that the target computer device can quickly resume the running of the virtual machine by reading the status information from the shared memory 130 at the specific memory locations upon receiving the switching notification.

In some embodiments, the computer devices 110 and 120 may have processing units with different processing unit types and/or different running OSs. For example, the processing unit type of the computer device 110 may be the x86 series CPU and the processing unit type of the computer device 120 may be an ARM processor. Also, the OS type of the computer device 110 may be a Window-based OS while the OS type of the window system 124 of the computer device 120 may be a Linux-based OS. As the actual hardware peripherals of the computer device 110 are not identical to that of the computer device 120, the computer device 120 may not be able to directly match to a specific hardware device used by the computer device 110. Several methods are thus provided to overcome the aforementioned hardware mismatch problems.

In one embodiment, for example, it is assumed that the computer device 110 comprises a pluggable device and the computer device 120 comprises a pluggable interface suitable for plugging in the pluggable device. In this case, after receiving the switching notification, the pluggable device may be first removed from the computer device 110 and then plugged into the computer device 120 to be used thereby via the pluggable interface. For example, the pluggable device may be a USB device supporting plug-and-play functions and thus the pluggable interface is the USB interface.

In another embodiment, if a specific hardware device used by the computer device 110 does not exist in the computer device 120, the second switching hypervisor 124 may further select a hardware device having similar functions as the specific hardware device as a corresponding hardware device from hardware devices of the computer device 120. For example, if a mouse device is used by the computer device 110 but it does not exist in the computer device 120, the second switching hypervisor 124 may select a hardware device with similar functions as the mouse device, such as a touch panel.

In another embodiment, if the specific hardware device used by the computer device 110 does not exist in the computer device 120 and no corresponding hardware device can be used, the second switching hypervisor 124 may implement the specific hardware device by software modules or the second switching hypervisor 124 may further communicate with the first switching hypervisor 114 to setup a virtual device which utilizes the original setting of the specific hardware device in the computer system 110 and then utilizes the virtual device via the connection interface 140 between the computer systems 110 and 120.

It is to be noted that, for explanation, only two computer devices are utilized to switch running of the virtual machine in the above embodiments, but the invention is not limited thereto. In other words, more than two computer devices may share the status information of the running virtual machine by direct access of the shared memory and may then apply the switching method of the invention to switch the virtual machine on different computer devices.

In summary, according to the apparatus and method for switching a running virtual machine between computer devices, especially for the management of a virtual machine running on a desktop or laptop platform consisting of homogeneous or heterogeneous CPUs, multiple virtual machine instances may be operated simultaneously. The virtual machine may be hosted on an apparatus with the same CPU system or on a computer system with a different CPU system via an instruction translator. Utilizing the switching hypervisor of the invention, essential states (e.g., states of CPU registers) of a virtual machine may be stored in a shared memory accessible by the multiple computer devices involved so that waiting time of the resuming of the virtual machine is shortened. That is, the switching hypervisor may transfer the states of the virtual machine via the shared memory without copying them from one computer device to another, so that the virtual machine can be dynamically switched to be run on homogeneous or heterogeneous computer devices and can be transferred between computer devices belonging to the same platform in real-time or near real-time.

Apparatuses and switching methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An apparatus for managing a running virtual machine, comprising:
a first computer device, having a first switching hypervisor on which a virtual machine runs;
a second computer device, having a second switching hypervisor, wherein the second switching hypervisor is in communication with the first switching hypervisor; and
a shared memory coupled to the first and second computer devices, being accessible by the first and second switching hypervisors,
wherein the first switching hypervisor stores status information of the virtual machine into the shared memory and when receiving a switching notification for switching the virtual machine to run on the second computer device, the first switching hypervisor halts its running of the virtual machine, and the second switching hypervisor obtains the stored status information of the virtual machine from the shared memory and resumes the running of the virtual machine on the second computer device according to the obtained status information of the virtual machine.

2. The apparatus of claim 1, wherein the second switching hypervisor further continuously stores the status information of the virtual machine into the shared memory when the status information of the virtual machine is updated.

3. The apparatus of claim 1, wherein the status information of the virtual machine at least comprises information regarding CPU registers and states, peripherals states, and the memory content of the virtual machine in the first computer device or the second computer device.

4. The apparatus of claim 3, wherein the information regarding the CPU registers and states, the peripherals states, and the memory content of the virtual machine in the first computer device are stored in specific memory locations of the shared memory and the second computer device retrieves the stored information therefrom to obtain the status information of the virtual machine.

5. The apparatus of claim 1, further comprising a connection interface coupled to the first computer device and the second computer device for the first switching hypervisor to communicate with the second switching hypervisor.

6. The computer device switching apparatus of claim 5, wherein the connection interface unit comprises a PCI-E bus.

7. The apparatus of claim 1, wherein the first switching hypervisor further selects a virtual machine setting among a plurality of predetermined virtual machine settings to be the running virtual machine of the first computer device according to a predetermined setting or user selection.

8. The apparatus of claim 1, wherein the virtual machine further utilizes an instruction translator or an instruction emulator to simulate instruction sets of the first computer device when hardware architecture used in the virtual machine is different from that used in the first computer device.

9. The apparatus of claim 8, wherein the first computer device is an ARM-based computer device and the second computer device is a x86-based computer device or vice versa.

10. The apparatus of claim 9, wherein the first computer device further comprises a pluggable device and the second computer device comprises a pluggable interface suitable for plugging in the pluggable device, and after receiving the switching notification, the pluggable device is further removed from the first computer device and plugged into the second computer device to be used thereby via the pluggable interface.

11. The apparatus of claim 9, wherein, if a specific hardware device does not exist in the second computer device, the second switching hypervisor further selects a hardware device having similar functions with the specific hardware device as a corresponding hardware device or implements the specific hardware device by software modules.

12. The apparatus of claim 9, wherein, if a specific hardware device does not exist in the second computer device, the second switching hypervisor further communicates with the first switching hypervisor to setup a virtual device which utilizes the original setting of the specific hardware device in the first computer device via the connection interface between the first and second computer devices.

13. The apparatus of claim 1, wherein the first and second computer devices have heterogeneous CPUs.

14. A switching method for switching a running virtual machine between computer devices in an apparatus comprising at least first and second computer devices and a shared memory coupled therebetween, wherein the first computer device has a first switching hypervisor on which a virtual machine runs and the second computer device has a second switching hypervisor, which is in communication with the first switching hypervisor, comprising:
storing status information of the running virtual machine into the shared memory by the first switching hypervisor of the first computer device when the virtual machine runs on the first computer device;
receiving a switching notification for switching the virtual machine to the second computer device;
halting, by the first switching hypervisor, the running of the virtual machine; and
obtaining, by the second switching hypervisor, the stored status information of the virtual machine from the shared memory and resuming the running of the virtual machine on the second computer device according to the obtained status information of the virtual machine.

15. The switching method of claim 14, further comprising:
continually storing the status information of the virtual machine into the shared memory when the status information of the virtual machine is updated.

16. The switching method of claim 14, wherein the status information of the virtual machine at least comprises information regarding CPU registers and states, peripherals states, and the memory content of the virtual machine in the first computer device or the second computer device.

17. The switching method of claim 16, wherein the information regarding the CPU registers and states, the peripherals states, and the memory content of the virtual machine in the first computer device are stored in specific memory locations of the shared memory and the second computer device retrieves the stored information therefrom to obtain the status information of the virtual machine.

18. The switching method of claim 14, further comprising:
selecting, by the first switching hypervisor, a virtual machine setting among a plurality of predetermined virtual machine settings to be the running virtual machine of the first computer device according to a predetermined setting or user selection.

19. The switching method of claim 14, wherein the virtual machine further utilizes an instruction translator or an instruction emulator to simulate instruction sets of the first computer device when hardware architecture used in the virtual machine is different from that used in the first computer device.

20. The switching method of claim 14, wherein the first computer device further comprises a pluggable device and the second computer device comprises a pluggable interface suitable for plugging in the pluggable device, and after receiving the switching notification, the pluggable device is further removed from the first computer device and plugged into the second computer device to be used thereby via the pluggable interface.

21. The switching method of claim 14, wherein, if a specific hardware device does not exist in the second computer device, the second switching hypervisor further selects a hardware device having similar functions with the specific hardware device as a corresponding hardware device or implements the specific hardware device by software modules.

22. The switching method of claim 14, wherein the first and second computer devices have heterogeneous CPUs.
